(19) United States
(12) Patent Application Publication
(10) Pub. No.: US 2005/0095078 A1
(43) Pub. Date: May 5, 2005

(54) Blind nut

(76) Inventor: Takanori Makino, Toyohashi-shi (JP)

Correspondence Address: HARNESS, DICKEY & PIERCE, P.L.C., P.O. BOX 828, BLOOMFIELD HILLS, MI, 48303, US

(21) Appl. No.: 10/953,691

(22) Filed: Sep. 29, 2004

Related U.S. Application Data
(63) Continuation of application No. PCT/US03/11254, filed on Apr. 10, 2003.

(30) Foreign Application Priority Data
Apr. 11, 2002 (JP) 2002-108871

(51) Int. Cl. F16B 37/04

(52) U.S. Cl. 411/183

(57) ABSTRACT

A blind nut (1) is formed as a single-piece component of plastically deformable material such as metal. The blind nut (1) comprises a hollow internally threaded portion (2), a hollow tubular portion (3) extending continuously from the internally threaded portion (2), and a flange (5) provided at the end of the tubular portion (3) and formed with an opening in communication with the cavity of the tubular portion (3). The internally threaded portion (2) is fixed to a workpiece by inserting the tubular portion (2) into a mounting hole (13) of the workpiece and causing a buckling deformation in a portion of the tubular portion (2) to clamp the workpiece between the deformed portion (17) and the flange (5). The internally threaded portion (2) includes a thin-walled segment (7) having a certain axial length which extends from the end of the internally threaded portion (2) toward the tubular portion (3). The thin-walled segment (7) has an inner diameter greater than that of the remaining segment of the internally threaded portion (2), and an inner surface without any internal thread.

### CROSS-REFERENCE TO RELATED APPLICATIONS

The present application is a continuation of pending International Patent Application No. PCT/EP03/11254, filed on Apr. 10, 2003 which designates the United States and was published in English, and claims priority of Japanese Patent Application No. 2002-108871, filed Apr. 11, 2002, which is incorporated herein by reference.

### FIELD OF THE INVENTION

The present invention relates to a blind nut made of plastically deformable material such as metal, and more specifically to a blind nut comprising a hollow tubular portion, a hollow internally threaded portion provided at the front end of the tubular portion, and a flange, wherein the internally threaded portion is fixed to a workpiece by inserting the tubular portion into a mounting hole of the workpiece to bring the flange into surface contact with the flange and causing a buckling deformation in the tubular portion so as to clamp the workpiece between the deformed portion and the flange.

### BACKGROUND OF THE INVENTION

There has been well known a blind nut formed as a single-piece component made of plastically deformable material such as metal, comprising a hollow internally threaded portion, a hollow tubular portion extending continuously from the internally threaded portion, and a flange formed at the end of the tubular portion and formed with an opening in communication with the cavity of the tubular portion, wherein the internally threaded portion can be fixed to a workpiece by inserting the tubular portion into a mounting hole of the workpiece to bring the flange into surface contact with the workpiece and causing a buckling deformation in the tubular portion so as to clamp the workpiece between the deformed portion and the flange. For example, such a blind nut is disclosed in Japanese Utility Model Laid-Open No. 58-186208. The setting operation of blind nuts can be performed from only one direction or one side. Thus, the blind nut is conveniently used for a setting operation to a workpiece such as a panel-like member which does not allow any operator to get at its backside. A bolt can be screwed into the blind nut fixed to the workpiece to attach another member to the workpiece through the screwed bolt.

Japanese Patent Laid-Open No. 2-159787 discloses a structure for setting a blind nut (nutsert) to a printed board to connect a bus bar and a circuit component electrically and mechanically. In that Japanese Patent Laid-Open No. 2-159787, a dedicated blind-nut setting tool is used to set the blind nut to the printed board. One example of such a dedicated blind-nut setting tool is disclosed in Japanese Patent Laid-Open No. 63-52974. That blind-nut setting tool includes a screw member protruding from the front end of the nose thereof. The screw member is adapted to engage with the thread of the internally threaded portion of the blind nut. The blind nut is attached to the front end of the tool by inserting the screw member of the tool into the internally threaded portion and screwing the internally threaded portion in the screw member of the tool so as to bring the flange into surface contact with the nose end while positioning the internally threaded portion on the front side. Then, the internally threaded portion of the blind nut at the front end of the tool is inserted into a mounting hole of a workpiece to bring the flange into surface contact with the workpiece. Under that condition, the tool is activated to strongly pull the internally threaded portion of the blind nut toward the flange, for example, by rotating the screw member of the tool, so as to cause a buckling deformation in the tubular portion formed between the flange and the internally threaded portion. As a result, the workpiece is clamped between the deformed portion and the flange, and thereby the internally threaded portion is fixed to the workpiece. This setting way is required to attach the blind nut to the setting tool one by one. The operation of attaching the blind nut to the screw member at the front end of tool is troublesome for an operator, and the requirement of attaching the blind nut to the setting tool one by one causes a time-consuming setting operation.

The inventor has carried out studies of setting the blind nut to a workpiece without using the above dedicated blind-nut setting tool. A method of setting the blind nut by use of a pressing tool or apparatus can achieve an advantageous setting operation in which preparation can be completed only by inserting the blind nut into a mounting hole of a workpiece without any requirement of attaching the blind nut to the setting tool one by one, and the blind nut can be set only by use of a pressing tool or apparatus to simplify the subsequent setting operation. However, if the conventional blind nut is set by use of the pressing tool or apparatus, the thread of the internally threaded portion will be undesirably damaged. The thread is more intensively damaged as the dimension of the thread of the blind nut becomes smaller. For example, in the blind nut with the internally threaded portion having a commonly used dimension or M3 (thread diameter: 3 mm) to M6 (thread diameter: 6 mm), the thread of the internally threaded portion was almost completely damaged. In experimental tests, an undesirable thread damage was caused in the blind nut having an internal thread of M12 (thread diameter: 12 mm) or less.

It is thereby an object of the present invention to provide a blind nut capable of advantageously facilitating an operation of setting the blind nut to a workpiece by use of a pressing tool or apparatus without using any dedicated blind nut setting tool.

### SUMMARY OF THE INVENTION

In order to achieve the above object, according to the present invention, there is provided a blind nut formed as a single-piece component made of plastically deformable material, comprising a hollow internally threaded portion, a hollow tubular portion extending continuously from the internally threaded portion, and a flange formed at the end of the tubular portion and formed with an opening in communication with the cavity of the tubular portion, wherein the internally threaded portion is fixed to a workpiece by inserting the tubular portion into a mounting hole of the workpiece and causing a buckling deformation in a portion of the tubular portion located on the opposite side of the flange so as to clamp the workpiece between the deformed portion and the flange. In this blind nut, the internally threaded portion includes a thin-walled segment having a certain axial length which extends from the end of the internally threaded portion toward the tubular portion. The thin-walled segment has an inner surface without any internal thread, and an inner diameter greater than that of the remaining segment of the internally threaded portion.

In the above blind nut, the internally threaded portion includes the thin-walled segment which extends from the end of the internally threaded portion toward the tubular portion and has an inner surface without any internal thread and a diameter greater than that of the remaining segment of the internally threaded portion. Thus, even if the blind nut is set to a workpiece by use of a pressing tool or apparatus, the thin-walled segment relaxes or absorbs the pressing force from the pressing tool or apparatus to prevent the pressing force from acting on the internal thread region of the internally threaded portion, resulting in causing no thread damage. This makes it possible to readily set the blind nut to a workpiece without using any dedicated blind-nut setting tool. In addition, the thin-walled segment provided in the internally threaded portion can prevent any thread damage even in the blind nut with the internally threaded portion having a dimension or M3 (thread diameter: 3 mm) to M6 (thread diameter: 6 mm).

In the blind nut of the present invention, the internal diameter of the thin-walled segment may be approximately equal to or slightly greater than the root diameter of the internal thread of the internally threaded portion. The axial length of the thin-walled segment may be greater than an axial length extending from the end of the internally threaded portion by a single pitch of the internal thread of the internally threaded portion. Further, the thin-walled segment may include a tapered region having an inner diameter gradually decreasing from the inner surface without any internal thread toward the internal thread region of the internal threaded portion.

In the above blind nut, the outer surface of the tubular portion may be formed with a plurality of longitudinally extending knurled grooves aligned with each other along the circumference of the tubular portion. In this case, the surface of the flange to be brought into contact with the workpiece may be formed with a protrusion to be bitten into the surface of the workpiece. Further, the outer surface of the tubular portion may be formed in a hexagonal or tetragonal shape in its cross section. The tubular portion may be formed with a slit extending longitudinally. When the workpiece is a pipe-like member having a curved side surface, the surface of the flange to be brought into contact with the curved side surface is preferably formed as a curved surface in conformity with the curvature of the side surface of the workpiece.

### BRIEF DESCRIPTION OF THE DRAWINGS

FIGS. 1A to 1C show a blind nut according to a first embodiment of the present invention, wherein FIG. 1A is a top plan view of the blind nut, FIG. 1B is a front view of the blind nut, and FIG. 1C is a sectional view of the blind nut taken along the line A-A in FIG. 1B.

FIG. 2 is a partial sectional front view showing the condition after the blind nut in FIG. 1 is set to a workpiece by use of a pressing tool or apparatus.

FIGS. 3A to 31B show a blind nut according to a second embodiment of the present invention, wherein FIG. 3A is a front view of the blind nut, and FIG. 3B is a sectional view of the blind nut taken along the line B-B in FIG. 3A.

FIGS. 4A to 4C show a blind nut according to a third embodiment of the present invention, wherein FIG. 4A is a front view of the blind nut, FIG. 4B is a bottom view of the blind nut, and FIG. 4C is a sectional view of the blind nut taken along the line C-C in FIG. 4A.

FIGS. 5A to 5D show a blind nut according to a fourth embodiment of the present invention, wherein FIG. 5A is a top plan view of the blind nut, FIG. 5B is a front view of the blind nut, FIG. 5C is a bottom view of the blind nut, and FIG. 5D is a sectional view of the blind nut taken along the line D-D in FIG. 5A.

FIGS. 6A to 6C show a blind nut according to a fifth embodiment of the present invention, wherein FIG. 6A is a front view of the blind nut, FIG. 6B is a bottom view of the blind nut, and FIG. 6C is a sectional view of the blind nut taken along the line A-A in FIG. 6A.

FIGS. 7A to 7B show a blind nut according to a sixth embodiment of the present invention, wherein FIG. 7A is a front view of the blind nut, and FIG. 7B is a sectional view of the blind nut taken along the line F-F in FIG. 7A.

FIGS. 8A to 8D show a blind nut according to a seventh embodiment of the present invention, wherein FIG. 8A is a top plan view of the blind nut, FIG. 8B is a front view of the blind nut, FIG. 8C is a left side view of the blind nut, and FIG. 8D is a sectional view of the blind nut taken along the line G-G in FIG. 8A.

FIG. 9 is a partial sectional front view showing the condition after the blind nut in FIG. 8 is set to a workpiece having a curved side surface by use of a pressing tool or apparatus.

### DETAILED DESCRIPTION OF THE PREFERRED EMBODIMENTS

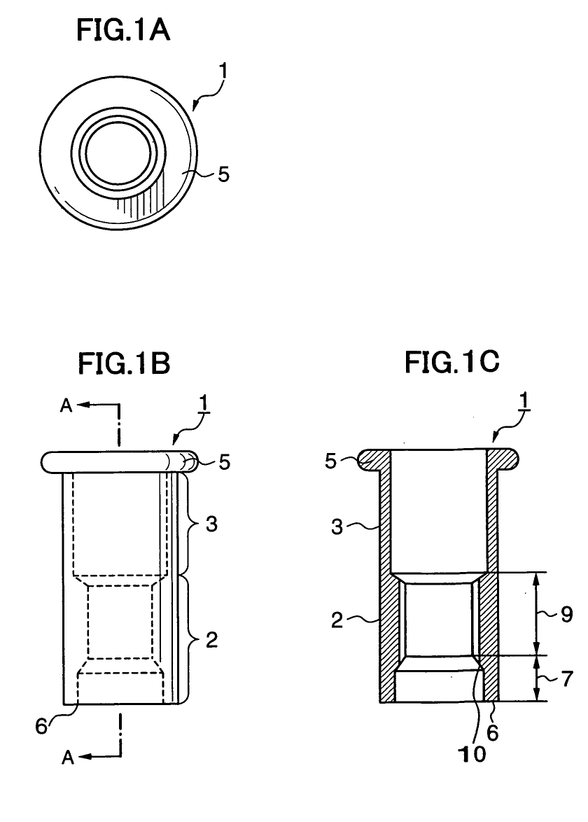

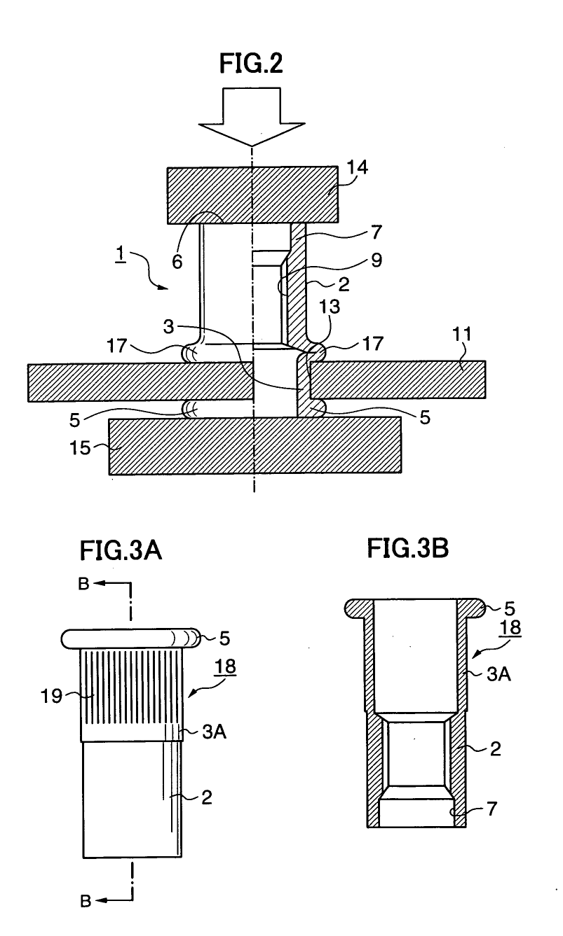

With reference to the drawings, various embodiments of the present invention will now be described. FIGS. 1A to 1C show a blind nut 1 according to a first embodiment of the present invention. The blind nut 1 is formed as a singe-piece component made of plastically deformable material such as metal. A typical material of the blind nut is a plastically deformable metal such as aluminum or steel, however, any other suitable plastically deformable material such as plastic materials may be used. The blind nut 1 comprises a hollow internally threaded portion 2, a hollow tubular portion 3 extending continuously from the internally threaded portion 2 toward the upper side in the drawing sheet of FIGS. 1A to 1C, and a larger-diameter flange 5 provided at the end (the upper edge in FIGS. 1B and 1C). The flange 5 is formed with an opening in communication with the cavity of the tubular portion 3 to allow the blind nut 1 to be formed as an entirely hollowed cylindrical body. In the blind nut 1 of the first embodiment, the internally threaded portion 2 and the tubular portion 3 are formed in a circular cylindrical outer shape having the same outer diameter, and the flange 5 is formed in a circular shape. The tubular portion 3 formed between the internally threaded portion 2 and the flange 5 has a thinner wall than that of a portion of the internally threaded portion 2 adjacent to the tubular portion 3. That is, the tubular portion 3 is configured to be partially deformed outward or cause a buckling deformation by applying a strong force capable of reducing the distance between the internally threaded portion 2 and the flange 5. Thus, the internally threaded portion 3 can be fixed to a workpiece by inserting the tubular portion 3 into a mounting hole of the workpiece to bring the flange 5 into surface contact with the workpiece and then causing a buckling deformation in a portion of the tubular portion 3 so as to clamp the workpiece between the deformed portion and the flange 5 (see FIG. 2).

In this embodiment, the internally threaded portion 2 includes a thin-walled segment 7 having a certain axial length which extends from the end 6 of the internally threaded portion 2 toward the tubular portion 3. The thin-walled segment 7 has an inner surface without any internal thread, and an inner diameter greater than that of the remaining segment of the internally threaded portion 2. The internal diameter of the thin-walled segment 7 is designed to be approximately equal to or slightly greater than the root diameter of the internal thread in the remaining segment or threaded segment 9 of the internally threaded portion. The axial length of the thin-walled segment 7 is set to be greater than an axial length of a single pitch of the internal thread of the internally threaded portion 2 extending from the end 6 of the internally threaded portion 2. Thus, the thin-walled segment 7 is undoubtedly distinguished from both the end region of the conventional internally threaded portion having a threaded inner surface extending to its end (the end 6 in FIG. 1), and a so called “chamfered portion” formed at the end. The length of the thin-walled segment 7 may be arbitrarily set, but it may be typically set at about two pitches of the internal thread. Further, in the illustrated embodiment, the thin-walled segment 7 includes a tapered region 10 having an inner diameter gradually decreasing from the inner surface without any internal thread toward the internal thread of the threaded segment 9. Alternatively, the entire inner surface of the thin-walled segment 7 may be formed in a tapered shape having an inner diameter gradually decreasing from the end 6 to the edge of the internal thread of the threaded segment 9. Further, the thin-walled segment 7 may be formed in a straight circular cylindrical shape, and a step may be formed at the boundary between the thin-walled segment 7 and the threaded segment 9.

The thin-walled segment 7 can be formed, for example, by preparing the conventional blind nut with the internally threaded portion having the internal thread formed in its entire inner surface and removing the internal thread from the edge 6 by a certain axial length. Alternatively, after forming the thin-walled segment in a blank (not-completed product) in advance, the internal thread may be formed in the blank. In the illustrated embodiment, the hole of the thin-walled segment 7 is formed in a circular shape in its cross section. However, any other suitable shape such as tetragon, hexagon, star, ellipse or oval may be used as long as it does not work against an operation of inserting a bolt into the internally threaded portion 2 fixed to a workpiece.

FIG. 2 shows the condition after the blind nut 1 in FIG. 1 according to the present invention is set to a workpiece 11 such as a panel by use of a pressing tool or apparatus (only a press head 14 and a bed 15 are shown without other components) without using any dedicated blind-nut setting tool. The setting operation will be described with reference to FIG. 2. The workpiece is formed with a mounting hole 13 which allows the internally threaded portion 2 and the tubular portion 3 of the blind nut 1 to be inserted thereinto but does not allow the flange to pass therethrough. An operator manually aligns the blind nut 1 with the mounting hole 13 of the workpiece 11 by positioning the end 6 of the internally threaded portion on the font side, and inserts the internally threaded portion 2 and the tubular portion 3 into the mounting hole 13 to bring the flange 5 into surface contact with the workpiece 11. Then, the workpiece 11 having the blind nut 1 inserted therein is positioned such that the blind nut 1 is located immediately below the press head 14. The bed 15 of the pressing tool or apparatus is disposed under the press head 14, and thereby the blind nut 1 is disposed between the press head 14 and the bed 15. In FIG. 2, the flange 5 is placed on the bed 15, and the thin-walled segment 7 of the internally threaded portion 2 is disposed adjacent to the press head 14. This direction is not essential. Alternatively, the thin-walled segment 7 of the internally threaded portion 2 may be placed on the bed, and the flange 5 may be disposed adjacent to the press head 14.

As shown in FIG. 2, under the condition that the blind nut 1 is positioned between the press head 14 and the bed 15, the pressing tool or apparatus is activated so that the press head 14 presses the end 6 of the thin-walled segment 7 toward the flange 5 to apply to the tubular portion 3 a strong force capable of reducing the distance between the internally threaded portion 2 and the flange 5. This causes an outward deformation or buckling deformation in a portion 17 of the tubular portion 3 protruding from the workpiece 11 so as to clamp the workpiece 11 between the deformed portion 17 and the flange 5. By virtue of this clamping action, the blind nut 1 is fixed to the workpiece 11, and thereby the internally threaded portion is fixed to the workpiece 11. In experimental tests, when the blind nut 1 according to this embodiment was set to the workpiece by use of the pressing tool or apparatus, the thin-walled segment 7 was deformed while assuring its hole area capable of receiving a bolt therein, but the internal thread in the threaded segment 9 of the internally threaded portion 2 had no damage. This result would be obtained because the thin-walled segment 7 absorbs (or relaxes) the pressing force to be transmitted to the internal thread of the threaded segment 9 while receiving the strong pressing force from the press head 14. In addition, the press head 14 and the bed 15 has the contact with the adjacent thin-walled segment 7 of the internally threaded portion 2 but no direct contact with the threaded segment 9. This would also contribute to the prevention of thread damage. As above, the blind nut 1 according to this embodiment allowed the internally threaded portion 2 to be fixed to the workpiece 11 with no thread damage by use of the pressing machine without using any blind-nut setting tool. In the experimental tests, even the blind nut with the internally threaded portion having a dimension or M3 (thread diameter: 3 mm) to M6 (thread diameter: 6 mm) had no thread damage.

FIGS. 3A and 3B show a blind nut 18 according to a second embodiment of the present invention. The blind nut 18 comprises an internally threaded portion 2, a tubular portion 3A, and a flange 5, and the internally threaded portion 2 includes a thin-walled segment 7. In the blind nut 18 according to the second embodiment, the outer surface of the tubular portion 3A is formed with a number of longitudinally extending knurled grooves 19 aligned with each other along the circumference of the tubular portion 3A. The blind nut 18 has the same structure as that of the blind nut 1 in FIG. 1 excepting the knurled grooved 19. The knurled grooves 19 prevent the blind nut 18 from slipping with respect to a workpiece such as a panel when a bolt is screwed into and fixed to the internally threaded portion 2 after the blind nut is fixed to the workpiece. The tubular portion 3A is also formed in a cylindrical shape having an inner diameter slightly greater than that of the internally threaded portion 2. Another feature can be understood by referring to the description of the blind nut 1 in FIG. 1.

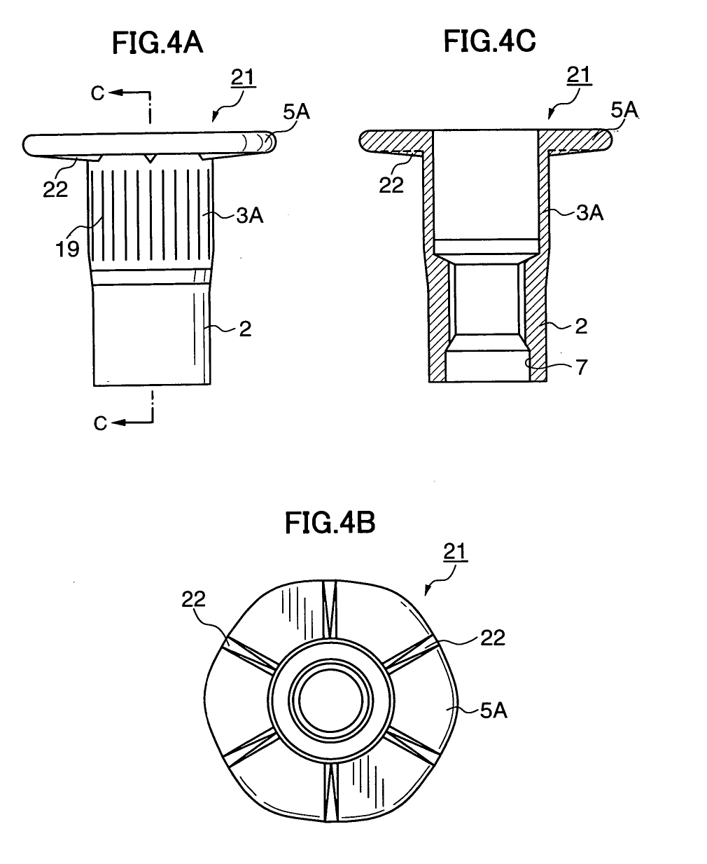

FIGS. 4A to 4C show a blind nut 21 according to a third embodiment of the present invention. The blind nut 21 comprises the internally threaded portion 2, a tubular portion 3A, and a flange 5A, and the internally threaded portion 2 includes the thin-walled segment 7. In the blind nut 21 according to the third embodiment, the outer surface of the tubular portion 3A is formed with a number of longitudinally extending knurled grooves 19 aligned with each other along the circumference of the tubular portion 3A, and the surface (the lower surface in FIGS. 4A and 4B) of the flange 5A to be brought into contact with a workpiece is formed with ribs 22 serving as protrusions to be bitten into the surface of the workpiece. Preferably, a plural number (six in the illustrated embodiment) of the ribs 22 are formed in a radial pattern at even intervals in the lower surface of the flange 5A, as shown in FIG. 4B. The flange 5A is formed as a large circular plate allowing the ribs to be formed therein. The knurled grooves 19 and the ribs 22 prevent the blind nut 21 from slipping with respect to a workpiece such as a panel when a bolt is screwed into and fixed to the internally threaded portion 2 after the blind nut 21 is fixed to the workpiece. The blind nut 21 has the same structure as that of the blind nut 1 in FIG. 1 excepting the knurled grooved 19 and the ribs 22. If the slipping can be prevented only by the ribs, the blind nut 21 may omit the knurled grooves 19. Another feature can be understood by referring to the description of the blind nut 1 in FIG. 1.

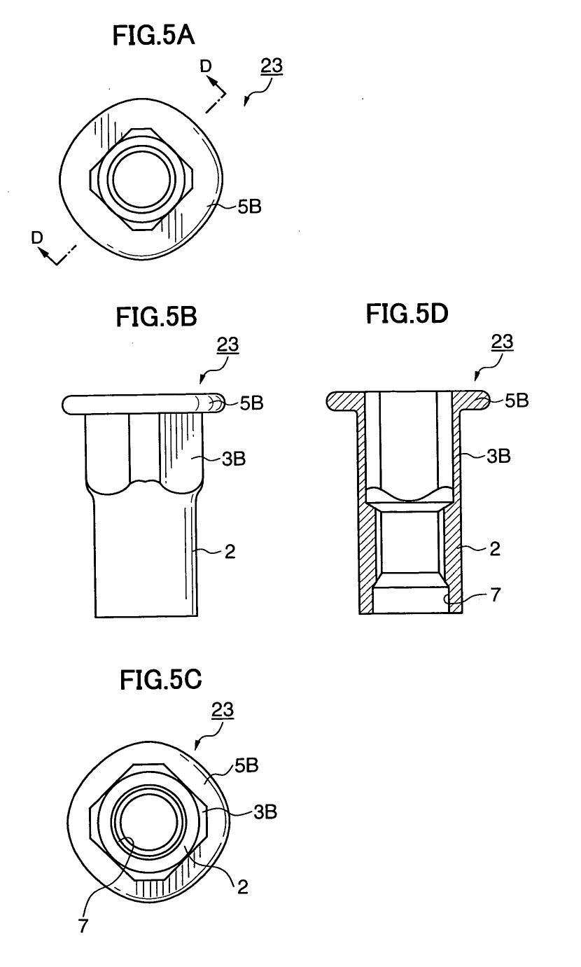

FIGS. 5A to 5D show a blind nut 23 according to a fourth embodiment of the present invention. The blind nut 23 comprises the internally threaded portion 2, a tubular portion 3B, and a flange 5B, and the internally threaded portion 2 includes the thin-walled segment 7. In the blind nut 23 according to the fourth embodiment, the outer surface of the tubular portion 3B is formed in a tetragonal shape in its cross section (see FIG. 5C). The inner surface of the tubular portion 3B may also be formed in a tetragonal shape in its cross section. The flange 5B provided at the end of the tubular portion 3B is formed as a large circular plate (or polygonal plate) in proportion to the tubular portion 3B. The tubular portion 3B having a tetragonal cross-sectional outer shape prevents the blind nut 23 from slipping with respect to a workpiece such as a panel when a bolt is screwed into and fixed to the internally threaded portion 2 after the blind nut is fixed to the workpiece. Thus, instead of a circular hole, a mounting hole of the workpiece is formed as a tetragonal hole in conformity with the tetragonal cross-sectional outer shape of the tubular portion. The blind nut 23 has the same structure as that of the blind nut 1 in FIG. 1 excepting the tetragonal cross-sectional outer shape of the tubular portion 3B. Another feature can be understood by referring to the description of the blind nut 1 in FIG. 1.

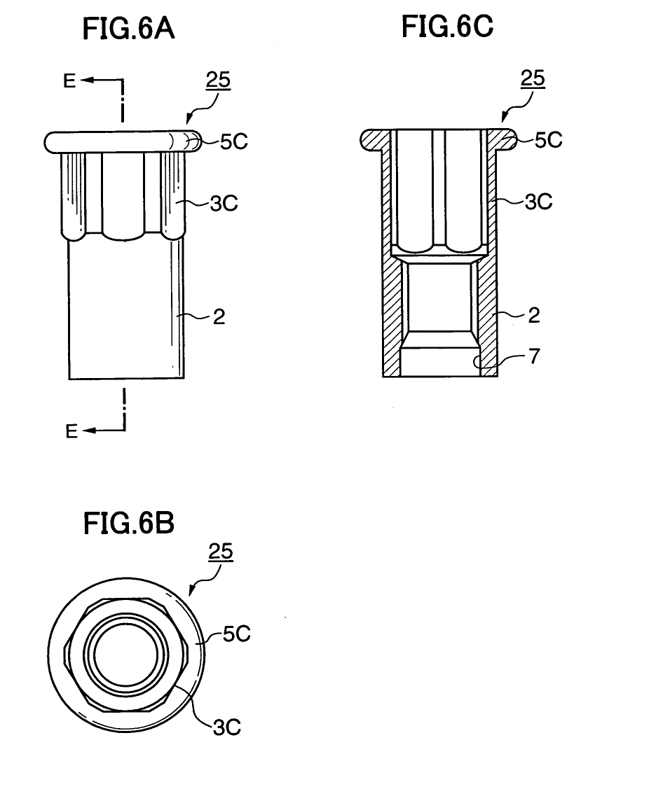

FIGS. 6A to 6C show a blind nut 25 according to a fifth embodiment of the present invention. The blind nut 25 comprises the internally threaded portion 2, a tubular portion 3C, and a flange 5C, and the internally threaded portion 2 includes the thin-walled segment 7. In the blind nut 25 according to the fifth embodiment, the outer surface of the tubular portion 3C is formed in a hexagonal shape in its cross section (see FIG. 6B). The inner surface of the tubular portion 3C may also be formed in a hexagonal shape in its cross section. The flange 5C provided at the end of the tubular portion 3C is formed as a circular plate (or polygonal plate) having a hexagonal opening in conformity with the tubular portion 3C. The tubular portion 3C having a hexagonal cross-sectional outer shape prevents the blind nut 25 from slipping with respect to a workpiece such as a panel when a bolt is screwed into and fixed to the internally threaded portion 2 after the blind nut 25 is fixed to the workpiece. Thus, instead of a circular hole, a mounting hole of the workpiece is formed as a hexagonal hole in conformity with the hexagonal cross-sectional outer shape of the tubular portion. The blind nut 25 has the same structure as that of the blind nut 1 in FIG. 1 excepting the hexagonal cross-sectional outer shape of the tubular portion 3C. Another feature can be understood by referring to the description of the blind nut 1 in FIG. 1.

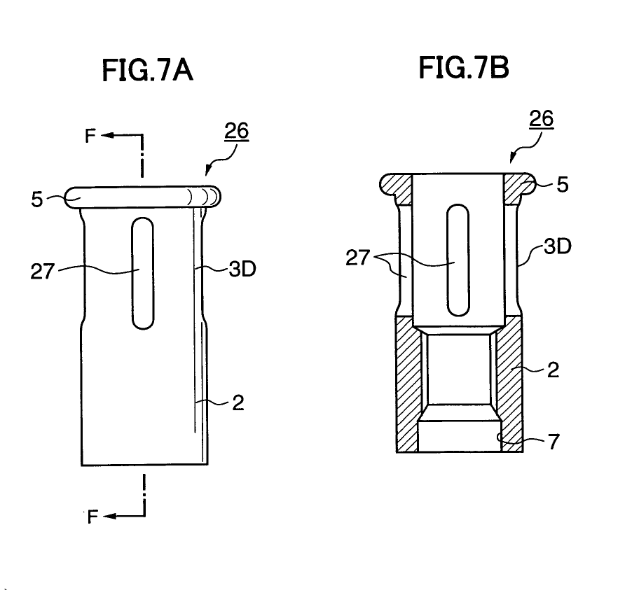

FIGS. 7A to 7B show a blind nut 26 according to a sixth embodiment of the present invention. The blind nut 26 comprises the internally threaded portion 2, a tubular portion 3D, and the flange 5, and the internally threaded portion 2 includes a thin-walled segment 7. In the blind nut 26 according to the sixth embodiment, the tubular portion 3D is formed with slits 27 extending longitudinally. A plural number (four in the illustrated embodiment) of the slits 27 are formed such that they are aligned with each other along the circumference of the tubular portion. The slits 27 allow the blind nut to be reliably fixed to the workpiece even if the workpiece is made of flexible material such as flexible plastic or the mounting hole of the workpiece is relatively large. The blind nut 26 has the same structure as that of the blind nut 1 in FIG. 1 excepting the slits of the tubular portion 3D having. Another feature can be understood by referring to the description of the blind nut 1 in FIG. 1.

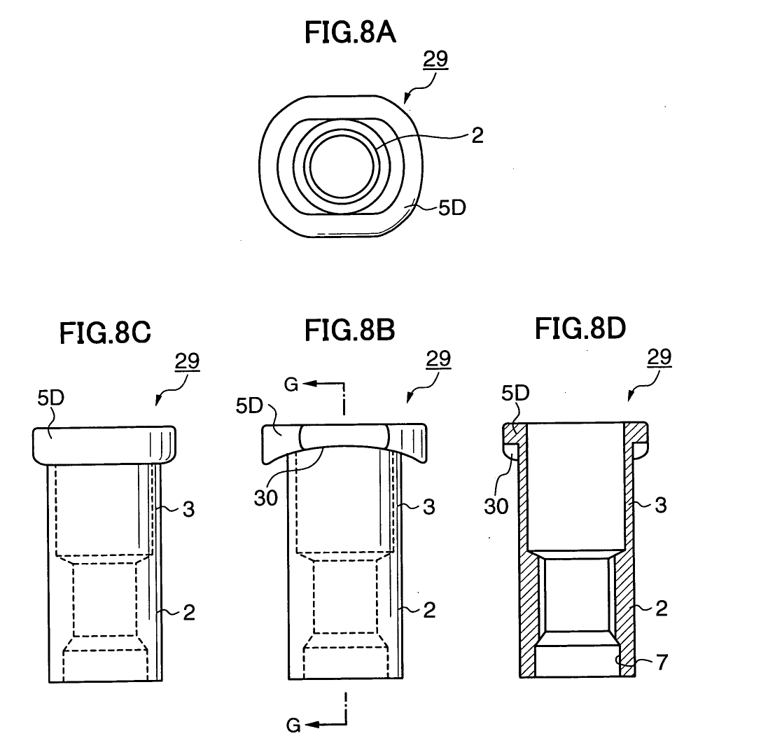

FIGS. 8A to 8D show a blind nut 29 according to a seventh embodiment of the present invention. The blind nut 29 comprises the internally threaded portion 2, the tubular portion 3, and a flange 5D, and the internally threaded portion 2 includes the thin-walled segment 7. In the blind nut 29 according to the seventh embodiment, the flange 5D is formed in a specific shape. More specifically, the flange 5D is formed in a shape conformable to a workpiece which is a pipe-like member having a curved side surface. Thus, a curved surface in conformity with the curvature of the side surface of the workpiece is applied to the surface of the flange 5D to be brought into contact with the curved side surface of the workpiece, i.e. the lower surface 30 of the flange 5D in FIG. 8D. As shown in FIG. 8A, the flange 5D is formed in a rectangular or oval shape in top plan view so as to contact the curved side surface of the workpiece. The curved surface 30 of the flange 5D allows the blind nut 29 to be stably attached to the workpiece without wobbling movement even if the workpiece is a pipe-like member having a curved side surface. The blind nut 29 has the same structure as that of the blind nut 1 in FIG. 1 excepting the shape of the flange 5D. Another feature can be understood by referring to the description of the blind nut 1 in FIG. 1.

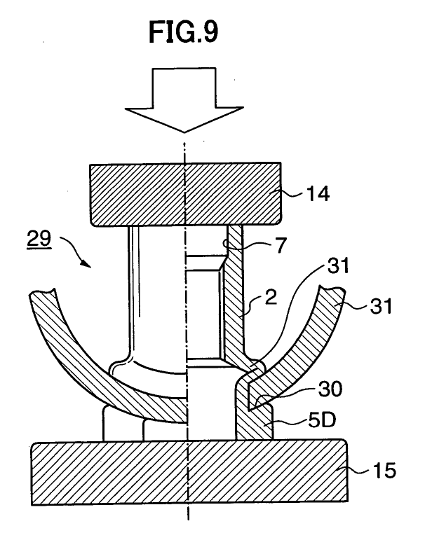

FIG. 9 shows the condition that the blind nut 29 according to the seventh embodiment has been set to a workpiece 31 having a curved side surface by use of a pressing tool or apparatus. The setting operation is the same as that described in the paragraphs [0013] and [0014], and its description will be omitted. Under the condition after the setting operation, the entire curved surface of the flange 5D stably contacts the curved surface of the workpiece 31, and thereby the blind nut 29 is firmly attached to the workpiece 31 having the curved side surface by a deformed portion 33 of the tubular portion 3 and the flange 5D. This blind nut 29 also allowed the internally threaded portion 2 of the blind nut 29 to be fixed to the workpiece 31 with no thread damage by use of the pressing machine without using any blind nut setting tool.

According to the blind nut according to the present invention, the internally threaded portion includes the thin-walled segment which extends from the end of the internally threaded portion toward the tubular portion and has an inner surface without any internal thread and a diameter greater than that of the remaining segment of the internally threaded portion. Thus, even if the blind nut is set to a workpiece by use of a pressing tool or apparatus, the thin-walled segment relaxes or absorbs the pressing force from the pressing tool or apparatus to prevent the pressing force from acting on the internal thread region of the internally threaded portion, resulting in causing no thread damage. This makes it possible to readily set the blind nut to a workpiece without using any dedicated blind-nut setting tool. In addition, the thin-walled segment provided in the internally threaded portion can prevent any thread damage even in the blind nut with the internally threaded portion having a small dimension or M3 (thread diameter: 3 mm) to M6 (thread diameter: 6 mm).

1. A blind nut formed as a single-piece component made of plastically deformable material, comprising a hollow internally threaded portion, a hollow tubular portion extending continuously from said internally threaded portion, and a flange formed at the end of said tubular portion and formed with an opening in communication with the cavity of said tubular portion, wherein said internally threaded portion is fixed to a workpiece by inserting said tubular portion into a mounting hole of said workpiece and causing a buckling deformation in a portion of said tubular portion located on the opposite side of said flange so as to clamp said workpiece between said deformed portion and said flange,
wherein said internally threaded portion includes a thin-walled segment having a certain axial length which extends from the end of said internally threaded portion toward said tubular portion, said thin-walled segment having an inner surface without any internal thread, and an inner diameter greater than that of the remaining segment of said internally threaded portion.

2. The blind nut as defined in claim 1, wherein said internal diameter of said thin-walled segment is approximately equal to or slightly greater than the root diameter of the internal thread of said internally threaded portion.

3. The blind nut as defined in claim 2, wherein said axial length of said thin-walled segment is greater than an axial length extending from the end of said internally threaded portion by a single pitch of the internal thread of said internally threaded portion.

4. The blind nut as defined in claim 3, wherein said thin-walled segment includes a tapered region having an inner diameter gradually decreasing from said inner surface without any internal thread toward the internal thread region of said internal threaded portion.

5. The blind nut as defined in claim 1, wherein the outer surface of said tubular portion is formed with a plurality of longitudinally extending knurled grooves aligned with each other along the circumference of said tubular portion.

6. The blind nut as defined in claim 5, wherein the surface of said flange to be brought into contact with said workpiece is formed with a protrusion to be bitten into the surface of said workpiece.

7. The blind nut as defined in claim 1, wherein the outer surface of said tubular portion is formed in a hexagonal or tetragonal shape in its cross section.

8. The blind nut as defined in claim 1, wherein said tubular portion is formed with a slit extending longitudinally.

9. The blind nut as defined in claim 1, wherein said workpiece is a pipe-like member having a curved side surface, wherein the surface of said flange to be brought into contact with said curved side surface is formed as a curved surface in conformity with the curvature of the side surface of said workpiece.
